(19) United States
(12) Patent Application Publication
(10) Pub. No.: US 2024/0290601 A1
(43) Pub. Date: Aug. 29, 2024

(54) MASS SPECTROMETRY DEVICE WITH SEGMENTED AND GRADUAL ION TRANSPORT CHANNEL

(71) Applicants: Hangzhou Calibra Diagnostics Co., Ltd., Hangzhou (CN); Hangzhou Calibra TECHNOLOGIES Co., Ltd., Hangzhou (CN)

(72) Inventors: Yabo WANG, Hangzhou (CN); Jianbing DU, Hangzhou (CN); Huafen LIU, Hangzhou (CN)

(21) Appl. No.: 18/352,733

(22) Filed: Jul. 14, 2023

(30) Foreign Application Priority Data
Feb. 23, 2023 (CN) 2023101582032

(51) Int. Cl. H01J 49/06

(52) U.S. Cl. CPC H01J 49/066; H01J 49/063

(57) ABSTRACT

The present invention relates to a mass spectrometry device containing an ion transport channel. The ion transport channel is a gradual ion transport channel, an inner diameter of the ion transport channel is gradually reduced, the strength of an electric field formed in the channel is gradually enhanced, and an area of an effective electric field is gradually reduced. Such a device allows ions to be transported stably in the transport channel and increasingly aggregated, thereby reducing the loss of ions, improving the sensitivity and resolution of later detection, and reducing the cost of the device.

### CROSS-REFERENCE TO RELATED APPLICATIONS

This application claims the priority of the prior Chinese application No. 202310158203.2 filed on Feb. 23, 2023, all contents of this application, including but not limited to, abstract, claims, description and services, are a part of the present invention.

### BACKGROUND OF THE INVENTION

### Field of the Invention

The present invention belongs to mass spectrometry devices in test setting, in particular to a mass spectrometry device containing an ion transport channel.

### Description of the Related Art

Mass spectrometry is an important branch of contemporary science and technology, the main content of which is a physical phenomenon that charged atoms or molecules are separated according to different mass-charge ratios in an electromagnetic field. Mass-to-charge ratio spectra of charged atoms and molecules with different mass-to-charge ratios can be obtained by changing the electromagnetic field according to certain parameters, which is called mass spectrogram. In mass spectrometry, mass-to-charge ratio is usually called mass number, the charged atoms and molecules are called ions and ion clusters, respectively, and ions and ion clusters are sometimes collectively called ions without causing confusion.

Generally, a mass spectrometer chamber requires a high vacuum degree to reduce the collision between ions and reduce the discharge of accelerated voltages between electrode rods. However, the general instrument is externally connected with liquid chromatography, substances may expand when the pressure changes from normal pressure to high vacuum state. In the process that charged compounds enter the high vacuum from the normal pressure, the compounds pass through a narrow channel and condense and deposit in the inner wall of a transport channel during transport, which may lead to the blockage of the channel as time passes, affecting the sensitivity of the instrument. Moreover, the transport channel is difficult to clean, and accessories must be replaced. In this way, when the instrument is used for a long time, there is deposition of residual substances in the channel, eventually affecting the accuracy of detection. In addition, whether the expanded substances can enter the transport channel and whether the expanded substances are lost in the transport channel also directly affect the resolution and sensitivity of subsequent tests.

Therefore, it is necessary to improve the ion transport channel of traditional mass spectrometry device to reduce the deposition of residual substances in the ion transport channel, as well as to improve the sensitivity of detection so as to ensure the resolution of detection.

### BRIEF SUMMARY OF THE INVENTION

In order to solve the defects of the conventional design and improve the accuracy or sensitivity of detection, a mass spectrometry device containing an ion transport channel is provided, in which the ion transport channel is a gradual ion transport channel. Here, “ions or particles” are ionized ions, which may be charged ions, or neutral ions without charge. These ions may enter the transport channel for transport, are separated after transport, and then enter a detector for detection.

In some preferred embodiments, an inner diameter of the transport channel is gradual. That is, an internal diameter of a space of the channel into which ions enter is gradual. Preferably, the channel is circular, and an internal diameter of the channel is gradually reduced from an ion inlet to an ion outlet. In the presence of an electric field, it may also be understood that an area of an effective electric field region is gradually reduced.

In some embodiments, the channel is enclosed by electrodes. The electrodes may be four electrodes, or eight electrodes, or more electrodes to enclose the channel. It may be understood that the channel enclosed by the electrodes is gradual, the electrodes must not be parallel, but non-parallel. In some embodiments, extension lines of the central axes of the electrodes enclosing the gradual channel intersect at a common point. The electrodes are cylindrical.

In some embodiments, the ion transport channel includes a first segment of channel and a second segment of channel. A length of the first segment channel is greater than that of the second segment of channel, and the first segment of channel is located at a front end of the second segment of channel. That is, one end of the first segment of channel is the ion inlet, and one end of the second segment channel is the ion outlet. In some embodiments, the first segment of channel includes eight electrodes, including four short electrodes and four long electrodes, the length of the four short electrodes is the same as that of the first segment of channel. In some embodiments, the second segment of channel includes four electrodes. The four electrodes are the same as or shared with the four long electrodes on the first segment of channel, or are extensions of the long electrodes at the first segment of channel. In some embodiments, the strength of an electric field at an inlet of the first segment of channel is less than that of the electric field at an outlet of the first segment of channel. In some embodiments, an effective electric field region at the inlet of the first segment of channel is twice as large as an effective electric field region at the outlet of the first segment of channel. The outlet of the first segment of channel is also an inlet of the second segment of channel. In some embodiments, the ion transport channel further includes a first lens, a second lens, and a third lens. The first segment of channel includes the first lens and the second lens, and the eight electrodes are arranged between the first lens and the second lens, or distributed around the channel by means of the first lens and the second lens. The four long electrodes are fixed by the first lens and the third lens and penetrates through the second lens.

In some embodiments, the long electrodes and the short electrodes are evenly spaced around the channel. Ions enter from the first segment of channel and then enter the second segment of channel without changing a voltage applied to the electrode. In this way, the ions move in a threaded way under the action of the electric field, such that the moving distance and route of the ions in the channel are increased, and the sensitivity can be improved. In particular, after multiple ions enter the channel, if the ions with close masses are close to each other, these ions may be separated together in a later separation stage, which may be easily mistaken for the same ion in the next ion detection. If the moving distance of the ions is increased under the action of the electric field, the distance between the ions with close masses can be increased to facilitate the accurate distinguishing of different ions in the later mass analysis. Therefore, the detection of different ions can be easily achieved under an ion detector, the detection result is more accurate, and the resolution is improved.

In some embodiments, the voltage and frequency applied to the long electrodes are the same as those applied to the short electrodes. No filter direct current electric field is applied to the ion transport channel, and only ROF (Radio over Fiber) and RF (Radio Frequency) voltages are applied, which only plays a role of aggregating ions. Moreover, no screening is made because no screening voltage (DC voltage) is applied. The ion transport channel according to the present invention is similar to allowing all charged ions to pass through without any screening. The screening work is conducted after the aggregated ions from the channel outlet enter the next step.

In some embodiments, the long electrodes and the short electrodes are rotatable, such that the electrodes can be cleaned easily, thus prolonging the service life of the electrodes. Too much cleaning of the electrode may lead to slight deformation of an inner surface, thus affecting the ion transport effect. Under this circumstance, if the electrode is rotated to make a deformed face rotate to an outer surface of the channel while making an undeformed face rotate to the inner surface of the channel, the electrode can be continuously used. Therefore, the electrode rod can be fully utilized, and the cost is reduced.

In some embodiments, the channel includes three layers of lenses, a gradual octupole, and a quadrupole. Therefore, the effect of effectively aggregating ions can be achieved. The electrode rods of the quadrupole or octupole can be rotated to avoid the situation that the ion transport effect is affected as the long-term cleaning of the electrode rods leads to the slight deformation of their inner surfaces. Two pairs of electrode rods are of a through-length, or have the same length as that of the whole channel, and the other two pairs of shortelectrode rods are combined with part of the long electrode rods in a larger circular inner diameter to form into the octupole.

The quadrupole or octupole here is the name of the electrodes. The quadrupole refers to four electrodes distributed according to a certain rule, and the octupole refers to eight electrodes distributed according to a certain rule. For example, the above first segment of channel is enclosed by eight electrodes, the eight electrodes may be called the octupole; and the second segment of channel is enclosed by four electrodes, the four electrodes may be called the quadrupole.

### BRIEF DESCRIPTION OF THE DRAWINGS

FIG. 1 shows a general process and principle of mass spectrometry detection;

FIG. 2 is a schematic diagram of a three-dimensional structure of an ion transport channel in a specific embodiment of the present invention with electrodes arranged around the channel;

FIG. 3 is a schematic diagram of a three-dimensional structure of a spatial distribution of electrodes;

FIG. 4 is a position structure diagram of three lenses L0-L2 for fixing electrodes, in which a channel enclosed by the electrodes is gradual, and the channel and electrodes are in a vacuum environment, so a housing is arranged outside the channel to ensure that the whole channel enclosed by the electrodes is in a vacuum or near vacuum environment;

FIG. 5 is a schematic diagram of a sectional structure of electrodes arranged on lenses;

FIG. 6 is a left view of an electrode distribution at a channel inlet;

FIG. 7 is a schematic cross-sectional view of the transformation from eight electrodes to four electrodes;

FIG. 8 is a schematic cross-sectional view of a channel enclosed by four electrodes;

FIG. 9 is a schematic cross-sectional view of an electric field formed by eight electrodes in accordance with the present invention;

FIG. 10 is a schematic cross-sectional view of an electric field formed by four electrodes in accordance with the present invention;

FIG. 11 is a schematic diagram of ion motion of ions entering a channel enclosed by four electrodes and an electric field;

FIG. 12 is a structure schematic diagram of a gradual channel according to an embodiment of the present invention;

FIG. 13 is a structure schematic diagram of a gradual channel according to an embodiment of the present invention;

FIG. 14 is a schematic diagram of a motion trajectory of ions in a channel according to an embodiment of the present invention.

### DETAILED DESCRIPTION OF THE INVENTION

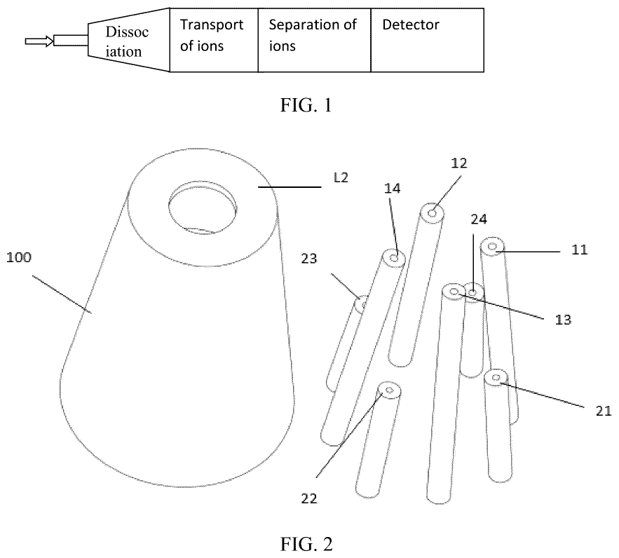

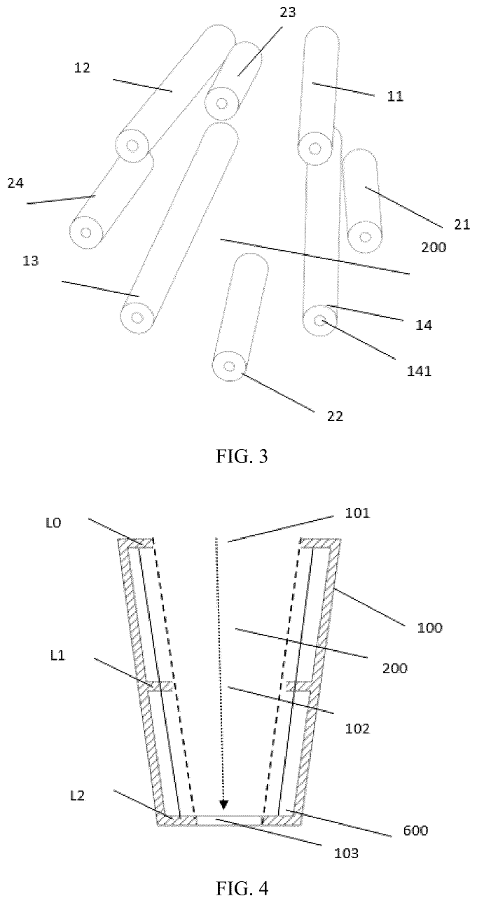

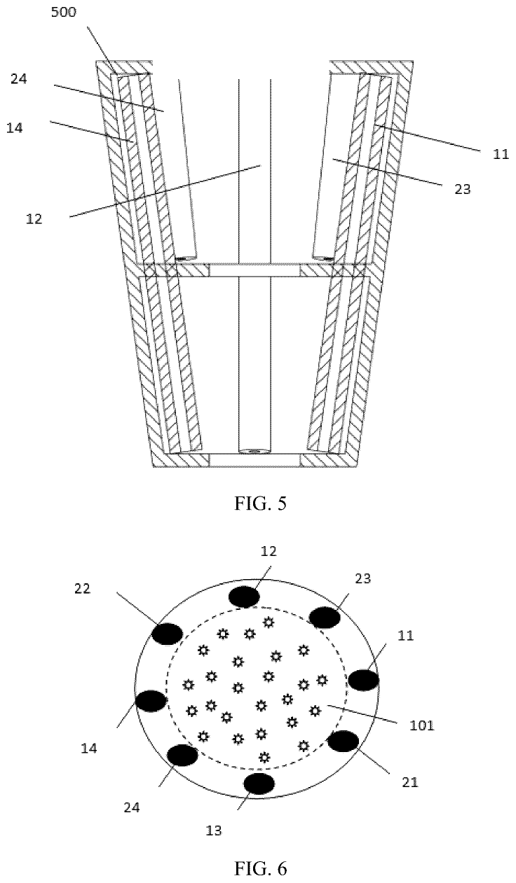

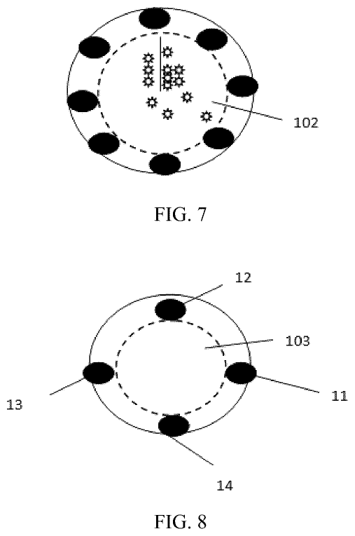

As shown in FIG. 2-FIG. 5, an ion transport channel is provided, including lenses L0-L2 and electrodes. The electrodes are connected by the lenses and distributed at intervals. In some embodiments, the three lenses L0-L2 have different outer diameters, such that the electrodes can be distributed on the lenses or connected together by the lenses, and an inner diameter of a hollow channel enclosed by the electrodes is gradually reduced, and the channel is a channel allowing ions to pass. That is, the inner diameter of the channel into which the ions enter is gradually reduced, and the distance between the center or central axis of the electrode and the center or central axis of the channel is also gradually reduced. In this way, under the dual action, the entering ions are more aggregated together with the changes of a physical space of the channel and the strength of an electric field, so as to improve the sensitivity for subsequent screening (as shown in FIG. 7-FIG. 8). For example, as shown in FIG. 4, the channel is provided with an ion inlet 101 and an ion outlet 103. The inner diameter of the channel is gradually reduced, similar to the form of a “horn”, and the electrodes are also obliquely distributed around the channel, and are connected together by the lenses. The whole channel and the electrodes enclosing the channel are in a closed space as a whole, such that a space where the whole channel and the electrodes are located is kept in a vacuum state through an external air extraction device. For example, as shown in FIG. 1, ions enter the transport channel from a dissociation space and then enter a separation channel, and these spaces are all in vacuum. The ions move forward under the action of the electric field.

Those of ordinary skill in the art should know that when a test sample is subjected to preliminary screening elution through a liquid phase, the sample contains a variety of analyte substances to be tested, such as some small chemical molecules. These small chemical molecules need to be specifically analyzed by mass spectrometry, so as to obtain small-molecule structures. The general principle of the mass spectrometry is to dissociate these small chemical molecules and charge the same, so as to obtain charged particles or ions with a mass-to-charge ratio. These charged particles are subjected to screening and “weight” test, so as to obtain mass spectrometry. The liquid coming out from the liquid phase to an ion source outlet (low-pressure environment or normal-pressure environment) enters a low-pressure or near vacuum environment, and the liquid may expand to enlarge a distribution space. This requires as many particles (charged or neutral ions) as possible to aggregate and enter a mass spectrometry chamber, especially to enter a testing region for testing or separation before testing. However, if the ions in the sample are seriously lost in the transport process of entering the testing region, the types of ions reaching the testing area are reduced, naturally affecting the sensitivity of the testing. Meanwhile, if many ions with similar masses are close to or collide with each other during the transport, the testing accuracy is reduced. Theoretically, it is expected that all charged ions can enter the testing region and be effectively separated in a separation region, such that during testing, the sensitivity and accuracy can be guaranteed, and the detection range is wider.

According to the defects of the traditional technology, a gradual ion channel is designed, which not only allows more ions to enter the ion transport channel, but also allows more ions to be aggregated through the channel, thereby allowing more ions to enter the testing region and improving the sensitivity. In addition, with the increasing electric field strength and by combining the narrowing of the effective electric field space in the channel, the ions are more aggregated to form a real ion beam. Under the action of the electric field, the ions gradually move from a large circular motion to a reduced circular motion, which increases the moving distance of ions, keeps a proper distance between the ions with different masses, and reduces the collision between the ions.

The so-called gradual type includes two meanings: one is that the space of the ion transport channel is gradually reduced in physical sense. If the channel is circular, a diameter or radius of the circle is gradually reduced, and the gradual reduction enables the space of the effective electric field to be gradually reduced. The other is that the electrodes are distributed on a curved surface similar to a cone, and the density between the electrodes is gradually increased from the inlet for the ion inlet to the ion outlet, which makes the strength of the electric field have a gradual change. In this way, when ions enter the channel, under the dual action of gradually increased electric field strength and gradually decreased ion channel and physical radius, the ions are more aggregated together to reduce the loss of ions in the transport process, such that more ions can enter the testing region to be detected or tested, and the detection sensitivity is improved. In addition, the radius of the channel at the charged ions channel inlet is larger than that of the ion outlet, and the strength of the electric field at the charged ion channel inlet is relatively smaller than that of the ion outlet, such that the charged ions entering from the charged ion inlet enter the transport channel in an approximate vacuum environment from the conventional atmospheric pressure, and the charged ions expand. However, as the whole transport channel is similar to a “horn mouth”, more charged ions can enter the horn mouth. When the charged ions just enter the horn mouth, the opening of the transport channel is relatively large, while the electric field is relatively weak, more charged ions can enter the transport channel, and the accuracy range of detection is improved.

In some embodiment, the channel includes two segments, i.e., a first segment of channel D0 and a second segment of channel D1. Eight electrodes (octupole) 11, 12, 13, 14, 21, 22, 23, 24 are arranged on the first segment of channel, and four electrodes (also called quadrupole) 11, 12, 13, 14 are arranged on the second segment of channel. These electrodes are distributed at an equal distance in a conical space (FIG. 6), and the four electrodes 11, 12, 13, 14 arranged on the second segment of channel are the same electrodes as the long electrodes 11, 12, 13, 14 of the first segment of channel. That is, four electrodes 11, 12, 13 and 14 are arranged around the entire channel, and four short electrodes 21, 22, 23, and 24 are arranged between the electrodes at the first segment of channel, and the long electrodes and the short electrodes are distributed at intervals. In some embodiments, such an arrangement allows ions to enter the transport channel, and with the gradual enhancement of the electric field in the first segment of channel, the ions show a gradual aggregation. The advantage of such an arrangement is that the vacuum degree in the whole channel is getting higher and higher, and microscopically speaking, the ions have the function of diffusion in the process of transport (from a state of low vacuum to a state of high vacuum). Moreover, an inner diameter of the physical channel is getting smaller and smaller, if the strength of the electric field is enhanced more, the distance between the ions may be reduced or the ions may collide with each other, which affects the sensitivity and progress of subsequent tests. Theoretically speaking, in an ideal state, it is expected that more ions can be aggregated together, but the ions with different masses can be kept at a proper distance, or the ions with the same mass are kept at a proper distance, thus facilitating the effective separation in the later stage. Meanwhile, it is not expected to reduce the distance between the ions to reduce the chance of collision, and thus the sensitivity can be ensured without affecting the resolution. Therefore, a two-segment arrangement mode is adopted. In some embodiments, eight electrodes are distributed at the first segment of channel to receive the ions to enter the channel and to be aggregated in the channel. Four electrodes are distributed at the second segment of channel to aggregate the ions again, so as to reduce regions where the ions collide with each other. Afterwards, the ions after aggregation come out from the outlet to enter the next testing region, and the vacuum degree in the testing region is higher than that of an ion transport region.

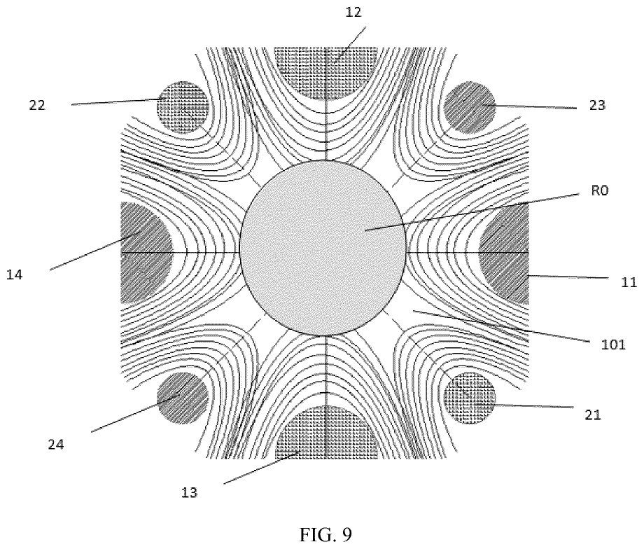

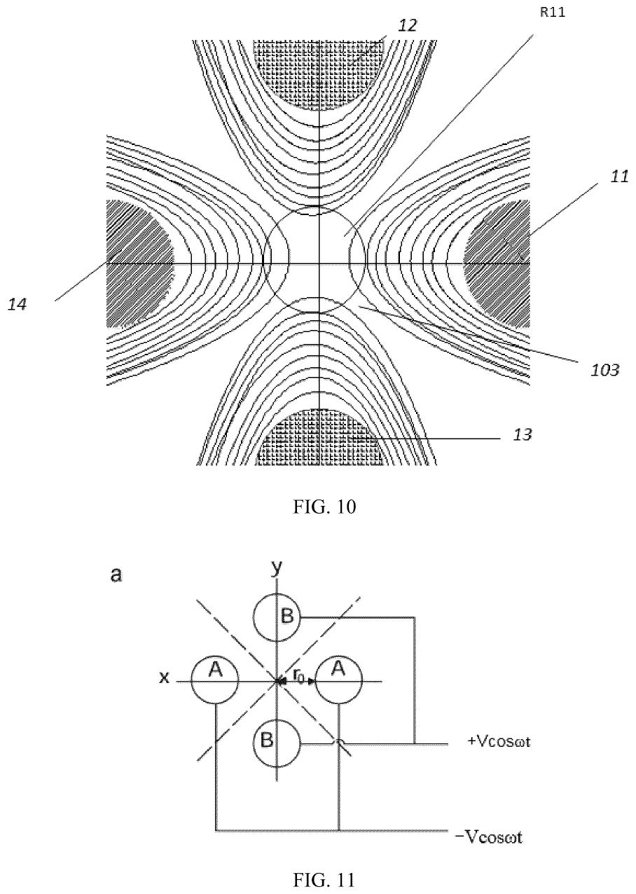

In some embodiments, an electric field is applied to the first segment of channel and the second segment of channel. The electric field is a radio frequency (RF) electric field, which provides a stable flight trajectory for ions by a fixed frequency voltage, such that the particles can be gradually aggregated together when moving in the electric field. From the cross section of the channel, as the physical inner diameter of the channel gradually decreases, the effective electric field area decreases, while the distance between the ions gradually decreases (laterally), such that the same number of ions can be distributed together more closely. Meanwhile, an axial compensation voltage is applied in the direction of the longitudinal axis of the channel, making the ions fly from the inlet of the channel to the outlet of the channel. Voltage application refers to that voltages are applied to both ends of the electrode. When multiple electrodes enclose a channel, an electric field (FIG. 9) is generated inside the channel, and an effective electric field region R0 is inevitably generated inside the electric field. The electric field has a frequency and changes periodically, thus making the ions spiral around the channel in the channel.

As the ion itself has weight, besides being aggregated by a lateral force of the electric field around the channel in a spiral motion, the ion also requires a thrust to move forward. The thrust may be the axial compensation voltage (ROF), and the voltage may be a direct current voltage, and is relatively low. No filtering direct current electric field is applied to the channel, and only ROF and RF voltages are applied, which only plays a role of aggregating. Moreover, no screening is made because no screening voltage (DC voltage) is applied. The ion transport channel according to the present invention is similar to allowing all charged ions to pass through without any screening. The screening work is conducted after the aggregated ions coming out from the channel outlet enter the next step.

The length of the channel depends on the length of the electrode. The longer the electrode, the more the vibration times of the ions increased, the better the resolution. However, the longer the electrode, the more difficult the machining. The thickness of the electrode also determines the resolution and sensitivity. However, if the electrode of the same specification is adopted, on the premise that the length and diameter are determined, it is difficult to improve the resolution and sensitivity. The problem is solved from the arrangement mode of the electrodes in accordance with the present invention, which can improve the resolution and sensitivity without increasing the length and thickness of the electrode. Generally, the diameter of the electrode is 3-20 mm, and the length is 30-60 times the diameter. For the present invention, an electrode with a diameter of 6 mm and a length of 30 mm is selected as the long electrode, and the short electrode has the same diameter and a length of 12 mm, thus forming a channel with a length of 30 mm and a gradually reduced diameter (arranged as in FIG. 2), allowing charged ions with different masses to enter the channel, and the same voltage and frequency are applied to the electrodes. Through the testing of ion accuracy and resolution (simulated testing by computer program), with the sensitivity, the ion with a weight unit of 5 ucan be detected, and the detection range is 5-9000 u, which is the result of computer simulation. Likewise, when the traditional quadrupole is used, the length of the quadrupole is required to be 90-120 mm (the same diameter), the sensitivity of ion detection is only 50 u and more, and the range is 50-1,800 u. If the sensitivity and resolution need to be improved, the thickness and length of the electrode must be increased, which not only increases the difficulty of machining, but also increases the volume of the whole equipment.

For the ion channel of the so-called traditional quadrupole, the application of three types of voltages is required. In addition to the ROF and RF voltages of the present invention, a filtering DC (direct current) voltage is also applied, and ions are selected through specific DC voltages applied to the electrodes of the quadrupole. Moreover, the traditional quadrupole is arranged in parallel. Although ions are aggregated, the length and thickness of the quadrupole need to be increased if a better aggregation effect is desired.

In one embodiment, it may also be understood that both long and short electrodes are evenly distributed along fixed circumferential intervals, but the diameter or radius of the circumference is gradually and sequentially reduced. For example, as shown in FIG. 6-FIG. 8, FIG. 6 is a cross-section of the channel, and FIG. 7 is another cross-section of the channel. The spatial distance of the channel for ions to pass through is gradually reduced. For the arrangement of the electrodes, the electrode arrangement in FIG. 7 is closer than that in FIG. 6. In such an arrangement, the electric field is gradually enhanced, which changes the trajectory of the ions moving in the channel. How to change the trajectory will be explained in detail below. At the end of the channel, or the position with only four electrodes distributed, although there are only four electrodes, the transverse distance between the electrodes is smaller and closer than the starting end of the channel (FIG. 8), and the inner diameter of the channel is reduced more, such that the strength of the overall electric field may be smaller than that of the electric field with eight electrodes arranged. However, due to the close arrangement of the electrodes, the electric field is gradually enhanced in the space with only four electrodes, especially the effective electric field strength is increased. In this way, the effective electric field region is gradually reduced, and the state of ions in this region is the most stable, and more stable ions are aggregated together to facilitate the subsequent separation.

Specifically, the transport channel includes three lenses: the three lenses L0, L1 and L2 have gradually reduced inner diameters and different outer diameters, such that the electrodes are obliquely arranged or disposed on the lenses. The specific arrangement is as follows: each electrode has a circumferential surface and holes at both ends thereof. The holes penetrate through screws or the fixed lens, and each electrode is axially rotatable and fixed to the lens by ceramic insulation.

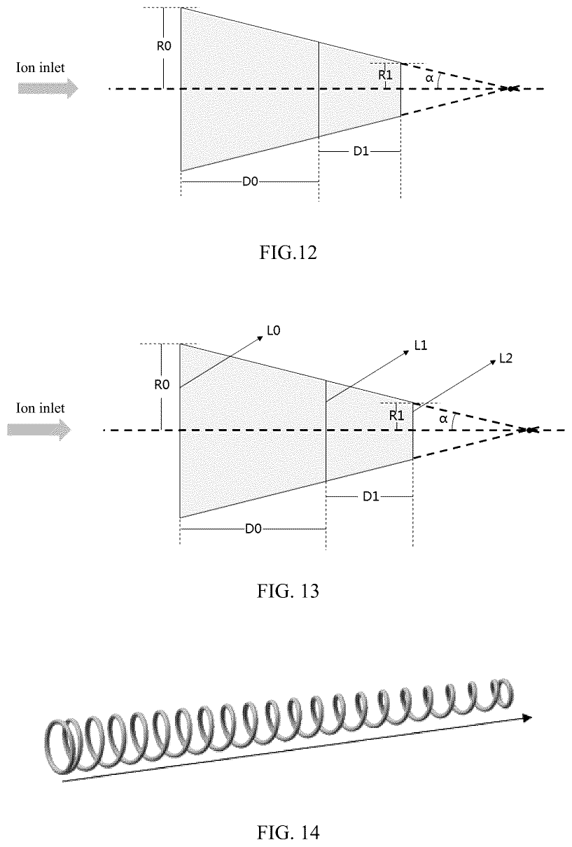

As shown in FIG. 12-FIG. 13, schematic diagrams of a gradual ion channel according to the present invention are provided. The gradual ion channel has two segments, the length of the first segment is D0, and eight electrodes are arranged in this region, in which four long electrodes penetrate through the D0 and D1 regions, while four short electrodes are only arranged in the D0 region. Thus, the lenses L0 and L1 are used to fix the octupole, and L1 and L2 are used to fix quadrupole. For the electrodes of the quadrupole, both segments (D0, D1) are provided, that is, four long electrodes are fixed by the lenses L0-L2, while short electrodes are fixed by the lenses L0-L1, thus forming a two-segment arrangement.

For example, as shown in FIG. 2-FIG. 5 and FIG. 12-FIG. 13, the four long electrodes penetrate through the lens L1, and both ends of the four electrodes are fixed to the lens L0 and the lens L2, respectively, while the four short electrodes are distributed only on the lenses L0-L1. The lens L0 and the octupole are threaded to the lens and insulated by insulating ceramics. One end (inlet end) of the octupole has an acute angle of 5-15° (500) with the lens L0, and each electrode is rotatable. The specific fixing method is that the center of the electrode is fixed to the lens L0 and the lens L1 through threads in a rotatable manner, and thus the electrode can rotate freely in the circumferential direction. The other end of the octupole penetrates through the lens L1 and is connected perpendicularly or at a right angle to the lens L1, while one end of each of the short electrodes 21, 22, 23 and 24 has an angle of 5-15° with the lens L0, and the other end of the short electrode is also perpendicular to the L1. In order to make the lens L1 perpendicular to all the electrodes, the lens L1 is inclined at an acute angle of 5-15° for compensating for an angle between the lens L0 and the electrode, thus being perpendicular to all electrodes, and satisfying the condition that one end of the electrode is perpendicular to the lens L1. Moreover, the lens L1 has no electric field, and only play a role of fixing the quadrupole or octupole.

The lens L2 is threaded to and insulated from QL (long electrodes 11, 12, 13, 14), and the lens L2 and QL are at an acute angle of 80° (600). When a voltage of the lens L0 is U1 and a voltage of the lens L2 is U2, E=(U1−U2)/D, (D is a horizontal distance between L0 and L2), D=D0+D1. A charged particle is q, a velocity of which passing through the ion transport channel is V, and V is the compensation voltage. The velocity of the ion moving in the channel (axial forward movement) and the velocity of the ion moving along the longitudinal axis are controlled. The voltage applied to the first segment of octupole r1L and its diagonal is V cos ωt, and the voltage applied to another group of octupole r1L and its diagonal is-V cos ωt. Similarly, the voltage applied to a set of diagonals Q0 is V cos ωt, and the voltage applied to another set of diagonals is-V cos ωt. In this way, the ions rotate spirally under the action of the electric field.

Assuming that an intersection of the L0 and a wireless extension line is Q, a horizontal distance between L0 and Q is C, a horizontal distance of dashed line is D2, tan α=R0/C, and the angle of α is 5-15°. The Ions rotate with a radius of F (XY plane) (inlet) when just entering the L0, rotate with a radius of F1 (eight electrodes) when reaching L1, in which F1<F, and rotate with a radius of F2 when entering L0 from L1 (four electrodes), in which F2<F1<F. Thus, the rotating radius of the ions in the transport channel is getting smaller and smaller, and the ions change from a state of expansion and dispersion to a state of more and more aggregated. That is, regardless of the octupole or the quadrupole, in the present invention, all the extension lines intersect at the same point Q (FIG. 12). As a whole, there is an inverted cone-shaped three-dimensional view, only the dashed line is missing, and the outlet has a radius R1, allowing the rotating ions to exit from the channel. Because the angle problems of the lenses L0, L1 and L2 for fixing the electrode rods are considered first, the electric fields released between the electrode rods of the quadrupole jointly act on particles orbits to make the ions move stably. Because the ions need to be in a symmetric electric field to reach a detector side, when the voltage is constant, the formation of the symmetric electric field requires physical electrode symmetry. If the electrodes do not intersect but are staggered, the effective region of the electric field is changed, and the motion of ions in the effective region is unstable, but changes, which may cause ions to collide with the surfaces of the electrodes and cause losses. If all the electrodes and the central axis of the channel intersect at one point, and the force received by the ions under the electric field is uniform, and the motion trajectory is stable, such that the aggregation state is stable, and the stability of subsequent separation and test is improved.

After neutral particles enter the transport channel with inertia (which are not affected by the electric field, only charged ions are affected by the electric field), the neutral particles which are condensed (temperature change) or having the gravity greater than the electric field force may collide with the inner wall of the transport channel, and thus uneven surfaces may be formed on the outer surfaces of the electrode rods for a long time, affecting the distribution of the electric field. It may be understood that the inner wall of the transport channel is actually enclosed by the outer surfaces of multiple electrodes. If the inner surface of the enclosed channel is in a constant state for a long time, it is expected that neutral particles in the motion are removed by vacuum pumping. However, the neutral ions may collide with the inner wall when moving in the channel, resulting in internal unevenness, and or may stay on the inner wall, resulting in accumulated precipitation formed on the inner wall for a long time, which also affect the distribution of the electric field. In order to solve this problem, the electrode of the present invention can rotate along the central axis of the electrode, on the one hand, the surface of the electrode enclosing the channel is kept consistent, thus keeping the consistency of the distribution of the electric field, and on the other hand, the cleaning of the surface of the electrode is facilitated, because the inner surface of the electrode rod may be irregularly scratched when cleaned with a brush for a long time, which affects the distribution of the electric field and reduces the transport efficiency of ions. Therefore, the electrode can rotate axially, such that the surface of the electrode enclosing the channel can change continuously to keep the physical property of the outer surface of the electrode enclosing the channel consistent and make the distribution of the electric field more consistent. Therefore, in the gradual transport channel, the inner surface can be rotated, and meanwhile, each smooth surface can be used for effective transport. The utilization rate of the electrode rod is greatly improved.

When multiple particles (charged) enter the transport channel, as a circular inner diameter of the transport channel enclosed by the octupole becomes smaller, the distribution of the electrode rods in the present application becomes smaller with the channel, and the electrodes are closer to each other on a smaller circumference. In a case that the voltages and frequencies applied to both ends of the electrodes are unchanged, the electric field is gradually enhanced, and the diffused particles can be aggregated together. For example, as illustrated in FIG. 2-FIG. 5 and FIG. 12-FIG. 13. In this case, as the ions enter the transport channel, except for neutral ions which are not affected by the electric field, other ionized ions spirally move along a large inner diameter of the channel from the inlet, and the further into the channel, the inner diameter for the spiral movement of the ions becomes smaller, and the ions are more aggregated.

In the particle transport channel, when the strength E0 of the electric field of the octupole is greater than the strength E1 of the quadrupole, and the effective electric field region R0 (diameter)=2R11 (radius) (FIG. 9-FIG. 10), the octupole can be transformed into quadrupole, which reduces the interaction between the rods of the segmented quadrupole. That is, when the effective electric field diameter in the transport channel is equal to twice the effective electric field radius, the number of electrodes changes from eight to four at this time. The reason for such an arrangement is that a divergent electric field line (the end connected to L1) may be formed at one end of the short electrode, the electric field line may interfere with a symmetrical electric field formed by the long quadrupole at the moment, and there is an electric field with a weak cross section in this region. When the particles reach the electric field with the weak cross section, the particles can pass through the electric field with the weak cross section due to a certain acceleration (velocity), so as to reach the next stable field region. However, when conventional segmented multipoles are combined, there is no other way for electric fields to cancel each other at the junction, so it is difficult for the particles to pass through the region with the cross section, which leads to more losses in the ion transport process and reduces the resolution of later detection.

When the ions enter the quadrupole assembly in a z direction (a dashed line direction in FIG. 9), one of the rods can exert attractive force on the ions, with the charge actually opposite to that of the ions. If the voltage applied to the rod is periodic, the attraction and repulsion in the x and y directions may alternate in time, and thus the polarity of the electric field also changes periodically in time. If an external radio frequency (RF) voltage is V and the frequency is ω, the total potential φ0 is: φ0=V cos Wt. Which causes the ions to still rotate in a spiral motion (as shown in FIG. 12).

The following embodiments are also part of the present invention.
1. A mass spectrometry device containing an ion transport channel, wherein the ion transport channel is a gradual ion transport channel, an inner diameter of the ion transport channel is gradually reduced, the strength of an electric field formed in the channel is gradually enhanced, while an area of an effective electric field is gradually reduced.
2. The device according to claim 1, wherein the transport channel is enclosed by four long electrodes, and extension lines of the central axes of all the long electrodes intersect at one point.
3. The device according to claim 2, wherein the central axis of the transport channel intersects with the extension lines of the central axes of the four long electrodes at the same point.
4. The device according to claim 3, wherein the channel is provided with an ion inlet and an ion outlet, an inner diameter of the inlet is larger than that of the outlet, and the strength of an electric field at the inlet is smaller than that of an electric field at the outlet.
5. The device according to claim 4, wherein the ion transport channel comprises a first segment of channel and a second segment of channel, a length of the first segment of channel is greater than that of the second segment of channel, the first segment of channel comprises the ion inlet and the second segment of channel comprises the ion outlet; the first segment of channel comprises eight electrodes, the eight electrodes comprise four long electrodes and four short electrodes, a length of each short electrode is the same as that of the first segment of channel, and extension lines of the four short electrodes intersect with an extension line of the central axis of the first segment of channel at the same point.
6. The device according to claim 5, wherein three lenses are provided on the channel, which are a first lens, a second lens, and a third lens; in the eight electrodes, the four short electrodes are fixed to the second lens through the first lens, the four long electrodes are fixed to the third lens through the first lens, and the four long electrodes penetrate through the second lens.
7. The device according to claim 6, wherein the second lens is located between the first lens and the third lens.
8. The device according to claim 7, wherein each of the eight electrodes comprises a first end and a second end, and the first end of each of the four short electrodes is connected to the first lens, and the second end of each of the four short electrode is connected to the second lens.
9. The device according to claim 7, wherein each of the eight electrodes comprises a first end and a second end, the first end of each of the four long electrodes is connected to the first lens, and the second end of each of the four long electrode is connected to the third lens.
10. The device according to claim 9, wherein included angles between the eight electrodes and the first lens are all acute angles ranging from 5°-15°, the eight electrodes are perpendicular to the second lens, and included angles between the four long electrodes and the third lens are all acute angles of 80°.
11. The device according to claim 10, wherein when an effective electric field region of the first segment of channel is twice that of the second segment of channel, the eight electrodes are transformed into four electrodes.
12. The device according to claim 10, wherein when an effective electric field region of the first segment of channel is twice that of the second segment of channel, the eight electrodes are transformed into four electrodes, and a second lens is provided on a boundary interface of the transformation.
13. The device according to claim 6, wherein the long electrodes and the short electrodes are evenly distributed around the channel at intervals, so as to enclose the ion transport channel; ions are able to enter from the first segment of channel and then enter the second segment of channel without changing voltages applied to the electrodes.
14. The device according to claim 6, wherein the voltage and frequency applied to the long electrodes are the same as those applied to the short electrodes, only ROF (Radio over Fiber) and RF (Radio Frequency) voltages are applied to the ion transport channel, and no filtering direct current electric field is applied, thus enabling charged ions to be more aggregated.

All patents and publications referred to in the description of the present invention indicate that these are disclosed techniques in the art and that the present invention may be used. All patents and publications cited herein are likewise listed in the bibliographies as each publication is specifically and individually referenced. The present invention described here may be implemented in the absence of any one element or more elements, a restriction or a plurality of restrictions, which are not specifically described herein. For example, in each instance here, the terms “contain”, “substantially consist of” and “consist of” may be replaced by the remaining two terms of one of the two. Here, the so-called “one” only means “one”, but it does not exclude that only one is included, and it may also mean that more than two are included. The terms and expressions employed here are descriptive and are not limited thereto, and there is no intention to indicate that the terms and interpretations described herein exclude any equivalent features, but it may be understood that any suitable changes or modifications may be made within the scope of the present invention and the claims. It may be understood that the described embodiments of the present invention are preferred embodiments and features, and that some modifications and variations may be made by any person of ordinary skill in the art in accordance with the essence of the description of the present invention. These modifications and variations are also considered to fall within the scope of the present invention and within the limits of the independent claims as well as the appended claims.

1. A mass spectrometry device comprising an ion transport channel, wherein the ion transport channel is a gradual ion transport channel, an inner diameter of the ion transport channel is gradually reduced, the strength of an electric field formed in the channel is gradually enhanced, while an area of an effective electric field is gradually reduced.

2. The device according to claim 1, wherein the ion transport channel is enclosed by four long electrodes, and extension lines of the central axes of all the four long electrodes intersect at one point.

3. The device according to claim 2, wherein extension lines of the central axis of the transport channel intersects with the one point of the extension lines of the central axes of the four long electrodes.

4. The device according to claim 3, wherein the channel is provided with an ion inlet and an ion outlet, an inner diameter of the inlet is larger than that of the outlet, and the strength of an electric field at the inlet is smaller than that of an electric field at the outlet.

5. The device according to claim 4, wherein the ion transport channel comprises a first segment of channel and a second segment of channel, a length of the first segment of channel is greater than that of the second segment of channel, the first segment of channel comprises the ion inlet and the second segment of channel comprises the ion outlet; the first segment of channel comprises eight electrodes, the eight electrodes comprise the four long electrodes and four short electrodes, a length of each short electrode is the same as that of the first segment of channel, and extension lines of the four short electrodes intersect with an extension line of the central axis of the first segment of channel at the same point.

6. The device according to claim 5, wherein three lenses are provided on the channel, which are a first lens, a second lens, and a third lens; in the eight electrodes, the four short electrodes are fixed to the second lens through the first lens, the four long electrodes are fixed to the third lens through the first lens, and the four long electrodes penetrate through the second lens.

7. The device according to claim 6, wherein the second lens is located between the first lens and the third lens.

8. The device according to claim 7, wherein each of the eight electrodes comprises a first end and a second end, and the first end of each of the four short electrodes is connected to the first lens, and the second end of each of the four short electrode is connected to the second lens.

9. The device according to claim 7, wherein each of the eight electrodes comprises a first end and a second end, the first end of each of the four long electrodes is connected to the first lens, and the second end of each of the four long electrode is connected to the third lens.

10. The device according to claim 9, wherein included angles between the eight electrodes and the first lens are all acute angles ranging from 5°-15°, the eight electrodes are perpendicular to the second lens, and included angles between the four long electrodes and the third lens are all acute angles of 80°.

11. The device according to claim 10, wherein when an effective electric field region of the first segment of channel is twice that of the second segment of channel, the eight electrodes are transformed into four electrodes.

12. The device according to claim 10, wherein when an effective electric field region of the first segment of channel is twice that of the second segment of channel, the eight electrodes are transformed into four electrodes, and a second lens is provided on a boundary interface of the transformation.

13. The device according to claim 6, wherein the long electrodes and the short electrodes are evenly distributed around the channel at intervals, so as to enclose the ion transport channel; ions are capable of entering from the first segment of channel and then entering the second segment of channel without changing voltages applied to the electrodes.

14. The device according to claim 6, wherein the voltage and frequency applied to the long electrodes are the same as those applied to the short electrodes, only ROF (Radio over Fiber) and RF (Radio Frequency) voltages are applied to the ion transport channel, and no filtering direct current electric field is applied, thus enabling charged ions to be more aggregated.
